(19) United States
(12) Patent Application Publication
(10) Pub. No.: US 2018/0118882 A1
(43) Pub. Date: May 3, 2018

(54) METHOD FOR CRYSTALLIZATION AND SEPARATION OF LOW-MOLECULAR COMPONENTS FROM A GRANULATE OF A CRYSTALLIZABLE THERMOPLASTIC MATERIAL AND DEVICE THEREFOR

(71) Applicants: UHDE INVENTA-FISCHER GMBH, Berlin (DE); THYSSENKRUPP AG, Essen (DE)

(72) Inventors: Rainer HAGEN, Berlin (DE); Udo MÜHLBAUER, Berlin (DE)

(73) Assignees: UHDE INVENTA-FISCHER GMBH, Berlin (DE); THYSSENKRUPP AG, Essen (DE)

(21) Appl. No.: 15/565,798

(22) PCT Filed: Apr. 11, 2016
(86) PCT No.: PCT/EP2016/057889

§ 371 Date: Oct. 11, 2017

(30) Foreign Application Priority Data
Apr. 14, 2015 (DE) 10 2015 206 688.6

(51) Int. Cl. C08G 63/90; C08G 63/08; B01J 19/24

(52) U.S. Cl. CPC C08G 63/90; C08G 63/08; B01J 2219/24; B01J 2219/00051; B01J 19/24

(57) ABSTRACT

A method may facilitate the crystallization of granules of a crystallizable thermoplastic material in conjunction with removal of low molecular mass components contained in the thermoplastic material. The crystallizable thermoplastic material may have a crystalline melting temperature of at least 130° C. According to the method, a crystallization stage and a removal stage may be performed at different temperatures of the granules. Often the crystallization may occur at a lower temperature than the removal of the low molecular mass components. In the crystallization and removal stages, a flow of gas may pass countercurrent to a direction along which the granules are conveyed. Further, example devices disclosed herein may be utilized to perform the exemplary methods disclosed herein.”

The present invention relates to a method which facilitates the crystallization of granules of a crystallizable thermoplastic material in conjunction with removal of low molecular mass components contained in the thermoplastic material. The method is notable in that the crystallization stage and the removal stage are carried out at different temperatures of the granules. The present invention relates, moreover, to a device for carrying out the aforesaid method.

PLA is prepared predominantly by ring-opening polymerization of lactide in the melt at final temperatures of between 160 and 200° C. The polymerization leads to a chemical ring-chain equilibrium in which, depending on the final temperature, there is between 3 and 5% of unconverted monomer present. The polymerization may alternatively be terminated at an incomplete conversion, in which case the monomer concentration may amount to up to 20% or more, depending on economic considerations. In either case, the unconverted monomer must be removed from the polymer in order to produce a PLA suitable for technical use. A condition for this is a residual monomer content of <0.5%, in order to prevent smoking, contamination, and lactide corrosion of the surroundings during processing from the melt. Furthermore, substantial concentrations of residual monomer adversely influence the mechanical and thermal properties of articles made from PLA. Not least, residual lactide in the PLA promotes the absorption of atmospheric moisture, and hydrolytic degradation.

Removal is accomplished on the industrial scale in general by evaporation under reduced pressure (reduced-pressure demonomerization). A wide variety of different apparatus has been proposed for this step, including devolatilizing extruders, thin-film evaporators, and rotating-disk reactors.

The industrial scale requires maximum product yield, and so the monomer removed must be returned to the process. Following evaporation under reduced pressure, therefore, the monomer has to be deposited in a suitable form and collected. The triple point of the monomer dictates whether the deposition can occur in solid or liquid form. If the aim is to deposit the lactide in liquid form, therefore, the reduced pressure which can be employed in removal from the melt cannot be below the pressure of the triple point. Consequently, the reduced pressure which can be employed is limited, and hence the residual monomer content as well. If operation takes place below the pressure of the triple point, a lower residual monomer content is achieved in the melt, but it is necessary to accept the deposition of the lactide in solid form. That generally entails discontinuous operation of the lactide deposition facility.

For monomer removal, EP 0 499 747 A2 proposes falling-strand devolatilizers, devolatilizing extruders or thin-film evaporators. The vapors from the devolatilization are deposited in one or more serially connected condensers. Reduced pressure is generated using single-stage or multistage assemblies which are otherwise unidentified and which generate a reduced pressure of down to 0.002 atm. (=2 mbar). In order to reduce the partial pressure of the lactide to be removed, and so to facilitate the evaporation and lower the residual monomer content of the polymer, the possibility is mentioned of adding entrainers such as nitrogen, toluene, ethylbenzene. Although not explicitly stated, the use of the term “condenser” and the pressure of 2 mbar suggest that the vapors are deposited in liquid form. At the same time, therefore, the reduced pressure which can be employed, and the residual monomer content, are limited. A drawback of this method is a comparatively high residual monomer content after monomer evaporation, if the lactide removed is deposited in liquid form above its triple point. If a pressure below the triple point is selected, the lactide must be deposited in solid form. To do so requires desublimators, which have to be operated discontinuously.

WO 98/36012 prefers a falling-strand devolatilizer for reduced-pressure evaporation, with the polymer melt falling downward in the form of filaments into a container which apparently is not under reduced pressure. Hot inert gas such as nitrogen or dry air is blown into the devolatilizer in order to aid the evaporation of the lactide from the surface of the falling filaments. The hot, lactide-containing gas, after departing the devolatilizing apparatus, is rapidly cooled to 20-40° C., the lactide being precipitated as a crystalline dust. This is preferably accomplished in a “crystallization chamber” by mixing with cold air. A drawback of this method is the mixing of the lactide with large quantities of inert gas, which make it difficult to recover the lactide entirely and necessitate very large apparatuses for separating the gas from the lactide dust (cyclone, gas filter). The most significant drawback, however, is that the demonomerization is carried out under atmospheric pressure and therefore a residual monomer content of 0.5% is unattainable. Apart from this, the falling-strand apparatus does generate a large surface area, but surface renewal is closely limited to the surroundings of the nozzle bores from which the melt emerges. Mass exchange performance overall, therefore, is limited, and residual monomer concentrations of the order of 0.5% are not attained even under reduced pressure.

EP 755 956 B1 describes a process wherein the PLA melt coming from the polymerization is granulated without demonomerization beforehand, the granules are crystallized, and the monomer they contain is evaporated from the granules at temperatures below the crystalline melting point, by means of a stream of inert gas.

A disadvantage of this process is the long residence time of the granules in the two apparatuses, of between 10 and 100 h, preferably between 20 and 50 h. The main reason for this time is the non optimum temperature of 120 to 140° C. which appears to be possible in this arrangement.

For the deposition of the removed monomer from the gas phase, condensation in solid form (desublimators) or liquid form is mentioned. Suitable apparatus identified for this purpose includes condenser, cyclone, filter, or a scrubber operated with lactic acid or melted lactide.

Lactide cannot be deposited completely from the inert gas stream in this way by scrubbing with liquid lactide. Because of the high temperature during scrubbing (>100° C. because of the melting point of lactide), in the course of the scrubbing of the exhaust gas with melted lactide, too much of the scrubbing liquid remains subsequently as vapor in the inert gas stream. If the inert gas is circulated, it must necessarily be cooled, and lactide is desublimated, contaminates pipelines, fittings, and fan, and causes rapid destruction of these components through abrasion.

Deposition below the melting point of the lactide leads to dusty residues, which form an aerosol and cannot be deposited entirely from the inert gas stream using the apparatus stated. Even in small amounts, lactide dust causes destruction of fans and other machines as a result of abrasion of moving parts.

Probably for this reason, the specification does not envisage circulating the inert gas. This is a considerable drawback, since both the gas and the monomer it contains must be recorded as losses, to the detriment of the economics of the method.

The specification acknowledges the problem of granule agglomeration during the crystallization, and attributes this phenomenon to melting and sticking as a result of excess temperature increase, caused by the heat of crystallization that is liberated. The specification, however, is silent as to the connection between this phenomenon and the crystallization rate and also the crystalline melting temperature of the PLA. In order to prevent agglomeration, the only measure it specifies is that the crystallization “is implemented in a state in which high fluidity of the PLA granules is maintained”. The way in which this must take place is not explained, and there is reference only to suitable apparatus performing this function.

The specification provides no details as to how the deposited lactide is returned to the polymerization and the point at which this takes place in the polymerization process sequence.

It is an object of the method of the invention, starting out from EP 755 956 B 1, to reduce the complexity of apparatus (the number of apparatuses and/or the residence time for removing the monomer from the PLA granules). A further object is to prevent the problem of agglomeration during the crystallization of the PLA granules, using less costly and inconvenient means. A third object of the invention is to deposit the monomer, removed from the polymer, completely in continuous operation without substantial losses and to return it to the PLA process, and to circulate the inert gas. The overarching objective is to lower the costs both of apparatus and of operation and so to enhance the economics of PLA production.

This object is achieved with a method in line with the features as claimed in claim 1. The object specified above is achieved, moreover, by an apparatus having the features of claim 15. The respective dependent claims represent advantageous developments.

The invention therefore relates to a method for crystallizing granules and removing low molecular mass components from granules of a crystallizable thermoplastic material having a crystalline melting temperature of at least 130° C., wherein granules of the crystallizable thermoplastic material are at least partially crystallized in a crystallization stage and subsequently low molecular mass components are at least partly removed from the at least partially crystallized granules in a removal stage, where the crystallization and the removal of the low molecular mass components take place at different temperatures, the crystallization preferably at lower temperatures than the removal.

The crystallization here takes place in the above-described crystallization stage. The granules used in the method may therefore be completely amorphous, though it is also possible for the granules already to have a certain semicrystallinity. This semicrystallinity may result, for example, from partial crystallization of the thermoplastic material that has taken place in the course of a granulation procedure undertaken in order to produce the granules, or else may come about from a separate partial-crystallization stage following the granulating step. Latent heat crystallization, as it is known, is suitable in particular for achieving semicrystallinity.

Surprisingly it has been recognized that with the procedure according to the invention, in which the temperature in the crystallization stage is decoupled from the temperature in the removal stage, it is possible to achieve an overall reduction in the residence time of the granules. As a result, the upper temperature limit for the demonomerization can be raised upwardly, in particular, as for example up to 5° C. below the melting point of the thermoplastic material, resulting in a shorter residence time.

According to one particularly preferred embodiment, the method of the invention is operated continuously, by continuous feeding of granules of the crystallizable thermoplastic material into the crystallization stage and continuous discharge from the stage following crystallization and following removal of the low molecular mass components.

In one preferred embodiment of the procedure according to the invention, the crystallization is carried out at a temperature below 20 K below the crystalline melting temperature of the crystallizable thermoplastic material, preferably at a temperature of between 80 K to 20 K below the crystalline melting temperature of the crystallizable thermoplastic material.

Alternatively or additionally to this, it is also preferred if the removal of the low molecular mass components is carried out at a temperature above the temperature used for the crystallization, preferably at a temperature above the temperature used for the crystallization up to a maximum of 5 K below the crystalline melting temperature of the crystallizable thermoplastic material.

It is further preferred according to the method of the invention that the granules in the crystallization stage and the removal stage are traversed by a flow of gas, the gas being passed preferably in countercurrent to a conveying direction of the granules, the gas more preferably being first fed into the removal stage and, after flowing through the granules in the removal stage, being withdrawn from the removal stage and subsequently fed into the crystallization stage, and flowing through the granules in the crystallization stage, where the gas preferably is nitrogen and/or dried air and more preferably has a dew point of <−20° C., more preferably of <−40° C.

It is further preferred in the method of the invention that the gas withdrawn from the separation stage, before being fed into the crystallization zone, is mixed with a gas of lower temperature or is cooled, and the gas mixture produced or the cooled gas is fed into the crystallization stage, the gas mixture produced or the cooled gas being adjusted preferably to a temperature below 20 K below the crystalline melting temperature of the crystallizable thermoplastic material. The gas of lower temperature is advantageously of the same quality as the gas used, particularly in terms of its composition and/or in terms of the dew point.

In particular, the granules, after passing through the removal stage, can be fed into a cooling stage and cooled, preferably to temperatures of <80° C., more preferably to <60° C., very preferably to less <50° C.

The granules may be cooled here indirectly in a shell-and-tube heat exchanger, with a gas whose temperature is lower than the granules temperature, with the granules flowing in the tubes, and the gas flowing in the gas counter-current around the tubes.

As an alternative to this, it is also preferred and possible for the granules to be cooled directly, by the granules being traversed by a flow of a gas whose temperature is lower than the granules temperature.

According to a further-preferred embodiment, the gas, after flowing through the granules in the cooling stage, is heated to a temperature of not more than 20 K below the crystalline melting temperature of the crystallizable thermoplastic material up to not more than 5 K below the crystalline melting temperature of the crystallizable thermoplastic material, and is fed into the removal stage. In this case, at least part of the gas is withdrawn from the cooling stage, heated, and fed into the removing stage.

The mass flow of the gas fed into the removal stage (or, optionally, into the cooling stage beforehand) corresponds preferably to at least 2.0 times, preferably to 2.5 to 5.0 times, more preferably to 2.8 to 3.2 times the mass flow of the granules fed in.

Alternatively or additionally to this, it is also possible for the selected heat capacity of the gas flow fed into the removal stage or the cooling stage, which is calculated as a product of the mass flow and the specific heat capacity of the gas, to be greater than the heat capacity of the granules flow, calculated as the product of the mass flow and the specific heat capacity of the crystallizable thermoplastic material, with the ratio of the heat capacity of the gas flow to the heat capacity of the granules flow preferably being adjusted to preferably between 1.25 and 2.5.

The granules preferably reside for between 0.5 and 10 h, preferably between 1 and 5 h, in the crystallization stage, and/or the crystallization is carried out to a degree of crystallization of 10 to 80%, preferably between 20 and 70%.

In the removing stage, the residence time of the granules is preferably between 1 and 30 h, more preferably between 1 and 10 h.

In particular, the granules in the crystallization stage are moved mechanically, being preferably stirred.

The procedure according to the invention allows the low molecular mass components to be removed down to a level of below 1 wt %, preferably below 0.5 wt %, more preferably of below 0.2 wt %.

In particular, the thermoplastic material is selected from the group consisting of polylactic acid and copolymers of lactic acid.

Copolymers of polylactic acid are copolymers which as well as lactic acid units also include further monomer units copolymerizable, or copolycondensable, with lactic acid or lactide; an example of such is glycolide and/or ϵ-caprolactone, which can be copolymerized with lactide to form the corresponding copolymers.

The polylactic acids which can be used correspondingly in the method of the invention are preferably selected from crystallizable polylactic acids, more particularly polylactic acids selected from the group consisting of poly-L-lactic acid having a maximum D-lactic acid unit content of 6%, or poly-D-lactic acid having a maximum L-lactic acid unit content of 6%. The D-lactic acid units in the poly-L-lactic acid may originate from D-lactide or meso-lactide, which are present in the reactants for preparing the poly-L-lactic acid, or in the case of preparation by racemization of an optically active carbon atom in the L-lactide. Similar comments apply with regard to the amount of L-lactic acid units in poly-D-lactic acid.

Low molecular mass components for removal here are preferably selected from the group consisting of lactide, lactic acid, and comonomers, more particularly 1-lactide, D-lactide and meso-lactide.

The method therefore enables in particular the removal of lactide and/or lactic acid from polylactic acid or copolymers having a crystalline melting temperature of at least 130° C.

In a further preferred embodiment of the method of the invention, the granules, immediately before being fed into the crystallization zone, are prepared by a chain-growth addition polymerization or polycondensation reaction in the melt and subsequent granulation of the resulting polymer, in the form of amorphous or semicrystalline granules (by latent heat crystallization).

Low molecular mass components present in the melt may be partly removed here prior to the granulation, in particular by means of a falling-strand evaporator. This partial removal preferably takes place under a pressure which is reduced relative to standard conditions, as for example in vacuo, in which case the low molecular mass compounds present pass over into the gas phase, by evaporation, for example.

It is further preferred if the gas stream, following withdrawal from the crystallization stage or the removing stage, is subjected to a purification, in which low molecular mass material contained in the gas flow is at least partly removed, the purified gas preferably being fed again into the removing stage or the cooling stage, and/or low molecular mass components removed being used again for producing the polymer.

The invention further relates to an apparatus for carrying out crystallization and removal of low molecular mass components from granules of a crystallizable thermoplastic material, comprising

a) a crystallization zone for granules of a crystallizable thermoplastic material, having an inlet and an outlet for the granules of the crystallizable thermoplastic material,

b) a removal zone for removing low molecular mass components from the granules of the crystallizable thermoplastic material, having an inlet and an outlet for the granules of the crystallizable thermoplastic material,

where the removal zone is downstream of the crystallization zone, and the crystallization zone and the removal zone are designed such that the crystallization and the removal of the low molecular mass components take place at different temperatures, the crystallization more particularly being carried out at lower temperatures than the removal of the low molecular mass components.

In one preferred embodiment of the apparatus, the removal zone has a supply line for heated gas, which is disposed preferably at the granules outlet of the removal zone or in the vicinity of the granules outlet, there being more preferably a gas heater upstream of the supply line.

It is further advantageous if the crystallization zone and the removal zone are in fluidic communication, with transport of the granules from the outlet of the crystallization zone to the inlet of the removal zone and transport of the gas from the removal zone to the crystallization zone being ensured.

It is preferred, moreover, if the granules outlet of the removal zone opens into a granules inlet of a granules cooler, the granules cooler having a feed for the cooling gas, the granules cooler preferably comprising, in the region of the granules inlet, a take-off facility for gas, which opens into a supply line for heated gas in the removal zone, which is disposed preferably at the granules outlet or in the vicinity of the granules outlet, there being more preferably a gas heater upstream of the supply line, and the take-off facility preferably opening into the gas heater.

The cooling effect of the granules cooler can be improved further by virtue of the granules cooler having at least one additional means for supporting the cooling of the granules. This may be done, for example, by means of internals of shell-and-tube kind, with granules being guided vertically through the tubes of the shell-and-tube assembly. A gas or a liquid is passed into the interstices between the tubes, and/or around the tubes, in order to cool the tubes and therefore the granules. The space around the tubes may be charged with air in the upper part of the cooler and with water in the lower part, with the space around the tubes being divided by a horizontal dividing wall. In that case, a supply line and removal line for air is needed in the upper part, and for water in the lower part.

Air cooling and water cooling may also take place in two coolers separate from one another. In the direction of flow of the granules, the water cooling is always positioned after the air cooling and has only a supplementary function, if the desired granules temperature of 50° C. is not achieved with air alone. The cooler may also consist of two separate parts, in which case the upper part cools the granules with air in direct contact, while the lower part cools the granules with water in indirect contact as above.

Alternatively or additionally to this, it is also possible to integrate cooling internals into the interior of the granules cooler, these internals entering into physical contact with the granules, the granules being able to flow through or wash over these internals.

The crystallization zone may have a gas outlet which opens into a scrubbing device for removing low molecular mass components from the gas flow, with preferably a liquid separator and/or a gas drier downstream of the scrubbing device, by means of which units the gas flow is freed from liquid, with the gas flow, following deposition and/or drying of liquid, being fed again into the granules cooler and the crystallization zone. With further preference there is a cooler upstream of the liquid separator and/or gas drier, and with this cooler, liquid can be condensed out of the gas before it enters the liquid separator and/or a gas drier. In this way, the drying of the gas is made easier.

In particular, the crystallization zone has a means for mechanically moving a bed of granules of a crystallizable thermoplastic material located in the crystallization zone, preferably a granules stirrer.

It is advantageous, furthermore, if crystallization zone, removal zone, and preferably the granules cooler are disposed together in a tower apparatus. In this case, preferably, crystallization zone, removal zone, and granules cooler are disposed vertically one above another in a tower apparatus, the crystallization zone being in communication with the removal zone via a perforated plate, the perforated plate being conical in design and having a central opening via which the granules can be transferred from the crystallization zone into the removal zone.

As an alternative to this, it is also preferred if crystallization zone and removal zone are disposed separately from one another and are in fluidic communication with one another via a granules line and also a gas line, preferably with removal zone and granules cooler being disposed in a tower apparatus.

A further possibility is that upstream of the granules inlet of the crystallization zone there is a granulating device for producing granules from a melt of a crystallizable thermoplastic material, the outlet of said device being in fluid communication via a granules line with the inlet of the crystallization zone, there being preferably a reactor, for producing a melt of a crystallizable thermoplastic material, upstream of the granulating device, with optionally, between reactor and granulator, a device for partial removal of low molecular mass components from the melt of the crystallizable thermoplastic material, more particularly a falling strand evaporator.

The present invention is elucidated in more detail by the observations which follow, without the invention being confined to specific details. The invention is described below for the example case of the removal of lactides from polylactic acid—this, however, is purely exemplary. The invention may also be carried out with other crystallizable thermoplastic polymers with removal of volatile compounds of low molecular mass that they contain.

According to the present invention, in particular, there are three embodiments according to which the method of the invention can be carried out.

According to a first embodiment (embodiment a) hereinafter), the crystallization and the demonomerization take place preferably in a vertical tower apparatus, with the crystallization zone disposed above the demonomerization zone.

An embodiment b) provides for demonomerization and crystallization to be carried out preferably in separate devices, with the crystallization zone being upstream of the demonomerization.

Embodiment c), illuminated in detail below, is based essentially on embodiment a); in this case, a melt of a thermoplastic material, such as polylactic acid, for example, is already demonomerized partly prior to the granulation.

### Course of the Method According to Embodiment a

The object stated at the outset is achieved in particular by a method wherein the monomer-containing PLA, following preparation by polymerization, is granulated and the amorphous granules are heated and crystallized in a single vertical tower apparatus by means of an inert gas flow, and are demonomerized below the crystalline melting point (embodiment a). The residence time is shortened by decoupling the granules temperature during crystallization and during the demonomerization. As a result, the upper temperature limit for the demonomerization can be extended to up to 5° C. below the PLA melting point, leading to a shorter residence time.

Agglomeration in the upper part of the apparatus, in which the crystallization takes place, is prevented by a stirrer with a vertical axis. Through appropriate guidance of the inert gas during the crystallization, the granules are adjusted to a temperature which is at least 20° C. below the melting point of the PLA to be crystallized. In the region of the tower apparatus situated below the crystallization zone, the temperature of the granules is increased to up to 5° C. below the crystalline melting point, and the demonomerization is completed in a residence time shortened in line with the increased temperature.

The monomer-laden inert gas departing the tower apparatus is cooled and washed with water in a gas scrubber. In this process, the monomer passes completely into the water. It is withdrawn from the scrubber circuit as an aqueous slurry or filter cake, and returned to the PLA process. The fully purified inert gas is circulated, meaning that neither significant losses of inert gas nor of lactide must be accepted.

It has been found that the residual monomer content in the granules of 0.2% can be achieved within a residence time of the granules in the apparatus of less than 20 hours. The method enables particularly economic demonomerization of PLA in terms of capital costs (number of apparatuses required) and operating costs (no generation of reduced pressure, no losses of lactide or of inert gas).

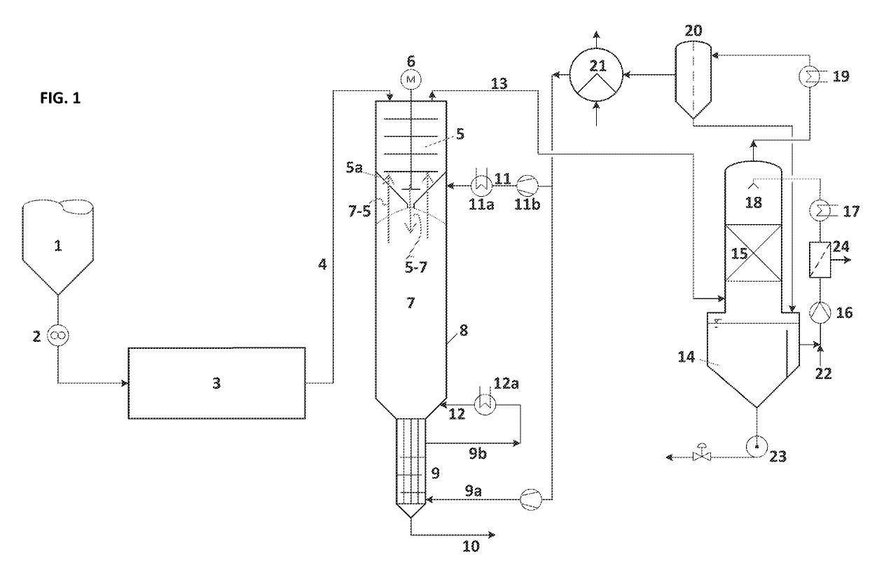

### The Course of the Method According to Embodiment a) is Shown in FIG. 1.

In a polymerization plant (not shown), 90% lactic acid is processed to lactide by polycondensation, with subsequent depolymerization of the resultant oligomer. The lactide, after being purified by rectification, is converted into PLA by ring-opening polymerization. The lactide content at the end of the polymerization can be between 2% and 20%, in other words between a monomer content which is dictated by the ring-chain equilibrium of PLA at the polymerization temperature used, and a monomer content which is established by premature determination of the polymerization. In a continuous plant, the reaction can be terminated, for example, by increasing the melt flow for a given reactor volume and hence a reduced residence time, or by using a low temperature, at which the residence time in the reactor is not sufficient for the lactide concentration to attain its equilibrium value. For embodiment a), a monomer content of up to 5% is preferred.

In the interests of economics, it is not possible to do without the monomer fraction. Following the removal of said fraction from the product, it must be recovered and returned to the PLA preparation process.

The monomer-containing melt is taken off from the polymerization reactor 1 by means of a gear pump 2 and supplied to a granulating device 3. A suitable granulating device is an underwater hot cut pelletizer, an underwater strand pelletizer or any other granulating device which produces granules having an average particle mass of between 5 mg and 100 mg. The particle shape may be spherical, cylindrical or prism-shaped, and is immaterial to the effectiveness of the method. Depending on the embodiment of the granulation, the granules may be produced in a crystalline form or in amorphous form. The method is described below for amorphous granules.

The amorphous granules are conveyed via a granules line 4 to the inlet of a tower apparatus 8. The granules flow in the form of a moving bed through the apparatus in countercurrent to an inert gas which takes on the functions of leading off the monomer and of heat transport. Suitable inert gases are gases which do not damage the PLA under the process temperatures, and more particularly do not give rise to any chain scission reaction (molar mass degradation), oxidation or discoloration. In particular, nitrogen and dried air (dew point temperature <−20° C., preferably <−40° C.) have proven suitable.

The tower apparatus 8 contains three zones in the flow direction of the granules: the crystallizer 5, the demonomerization 7 and the granules cooler 9. The crystallizer 5 converts the amorphous granules into the semicrystalline state. In the demonomerization zone 7, the desired residual monomer content is brought about in the granules. The granules cooler 9 lowers the temperature from the process temperature to a temperature below the glass transition (below 60° C., or even to below 50° C. depending on the optical purity of the lactide used for the polymerization).

In the crystallization zone 5, a degree of crystallization is established which is dependent on the selected granule temperature and on the prevailing residence time of the granules. The volume of the crystallization zone is designed so as to offer the granules flow a residence time of between 1 and 5 h. In the crystallizer 5 it is not necessary to establish, in the granules, the crystallization equilibrium corresponding to the selected temperature, this equilibrium being situated between a degree of crystallization of 30 and 70% according to the temperature and optical purity of the lactide used for the polymerization. It is sufficient for a degree of crystallization to be established that prevents the granules sticking together in the downstream demonomerization zone. This is already the case when the degree of crystallization is more than 10%, but preferably more than 20%.

A stirrer 6 with a vertically disposed shaft, on which blade-like stirring arms are attached, moves through the moving bed in the crystallizer 5 with a speed of rotation which may be between 0.1/ min and 5/ min. The speed of rotation is selected such that on the one hand the granules are prevented from sticking together during crystallization and on the other hand such that the torque to be applied remains low enough not to damage the stirring arms and not to cause any significant abrasion of the granules. The cross section of the stirrer blades is important to the method only insofar as the blades must on the one hand have sufficient mechanical stability and on the other hand are to experience as little resistance as possible in the course of their movement through the bed of granules. In principle, for example, the cross section may be rectangular, with the ratio of the long side to the short side of more than 20, the short side pointing in the running direction of the blade, and the edge being beveled in the running direction. The distance between the shaft wall and the circle described by the moving stirrer blades is less than 20 times the average particle diameter. At the bottom, the crystallizer is closed off by a hopper comprising perforated plate 5a. The perforations have a diameter of 1 mm, and so gas from below, air for example, is able to come from the removal zone 7 through the hopper and enter the crystallization zone 5 (represented by reference “7-5” in FIG. 1), but granules are unable to pass through at the bottom. The flow of granules departs the crystallization zone 5 in the direction of the separating zone 7 through a pipe connection (represented by reference “5-7” in FIG. 1) which is disposed at the hopper tip in the shaft axis.

Establishment of the various temperatures in the tower apparatus according to embodiment a) is accomplished by the division of the inert gas flow in accordance with the invention.

Closing off the crystallization zone 5 at the bottom by means of the perforated plate hopper 5a allows the inert gas ascending from the demonomerization zone to be admixed with a second inert gas stream 11 of lower temperature. As a result of effective mixing of the two gas streams in the granule-free volume beneath the perforated plate hopper 5a, the temperature of the first stream is lowered to such an extent as to allow the granules temperature operated in the crystallizer 5 to be lower than in the demonomerization zone 7. The granules temperature is established by means of the temperature (gas heater 11a) and the mass flow (fan 11b) of the gas stream 11.

The inert gas mass flow supplied in the lower section of the tower apparatus 8 according to FIG. 1 ought to be at least 2.0 times the mass flow of the PLA granules, preferably at least 2.5 times, and typically 3.0 times. The mass flow of the inert gas that is supplied in the upper section of the apparatus 8 is given a quantity and temperature such that the lower temperature desired in the crystallizer 5 is established after the two streams of inert gas are mixed. With a gas/granules mass flow ratio of 3.0 in the lower section and a gas entry temperature of 150° C., for example, the ratio is 0.5 for a gas temperature of 50° C. in the case of the gas mass flow supplied in the upper section. Accordingly, after the mixing of the two gas streams, a temperature of 120° C. is established ahead of the crystallizer 5 and hence also in the granules in the crystallizer 5.

In the crystallizer 5 a temperature is established which is at least 20° C. below the crystalline melting point of the PLA to be crystallized.

The granules flow departing the crystallizer 5 enters the lower section of the tower apparatus 8, the demonomerization zone 7. The temperature of the now semicrystalline granules is raised there to up to 5° C. below the crystalline melting point. This is accomplished by introducing an inert gas stream 12, preheated to the desired temperature, at the lower end of the demonomerization zone, before the granules enter the granules cooler 9. In this case, the heat capacity of the gas (the arithmetic product of the mass flow of the gas and its specific heat capacity) must be greater than the heat capacity of the granules (the arithmetic product of the mass flow of the granules and its specific heat capacity). The ratio of the heat capacity of the gas is preferably at least 1.5 times the heat capacity of the granules. Only in that case is it possible to establish the desired granules temperature by means of the temperature of the gas supplied.

For a residence time of the granules of 20 h in the demonomerization zone, preferably less, the residual monomer content is lowered to 0.2% or below.

The granules subsequently flow in the form of a moving bed into the granules cooler 9. This is preferably a shell-and-tube cooler. Granules flow through the tubes, which are cooled externally with water. It is advantageous, rather than water, to use a gas stream 9b downstream of the fan 12b and so to recover heat from the granules. In that case the gas heater 12a need only apply the heat difference in order to establish the precise temperature prior to entry into the demonomerization zone 7.

The temperature of the granules flow 10 at the exit from the cooler is below 60° C., preferably below 50° C. If this temperature is not achievable using the gas stream 12 alone, the upper section of the granules cooler 9 is designed for cooling with gas, the lowermost section for water cooling. The cooled granules can be run into a silo or go directly to packaging.

It will be appreciated that the inert gas stream takes up monomer not only on its path through the demonomerization zone 7 but also on its path through the crystallizer 5, although the quantity taken up in the latter is small, owing to the lowered temperature and the shorter residence time. The laden inert gas departs the apparatus above the crystallization zone, in the form of exhaust gas stream 13.

The laden inert gas is supplied to the scrubber 14. The latter consists of a packed column with an enlarged liquid-phase volume. The inert gas enters above the water level in the liquid phase and below the column packing 15, flows upward through the column packing 15, and is washed and cooled to the water temperature in countercurrent with water. In the course of this process, the gas gives up all of the monomer it contains to the water. Surprisingly here there is not even any aerosol left in the gas stream. A pump 16 withdraws the water from the liquid phase, conveys it through a cooler 17, and distributes it uniformly over the bed of packing by way of a distributor device 18, e.g., a spraying nozzle. The circulated quantity of scrubbing water is designed such that the inert gas stream takes on this water temperature completely. The cooler 17 sets the water temperature. Said temperature may be between 10° C. and 50° C., typically 30° C. The temperature is of minor importance to the method and may be selected according to economic aspects.

The liquid phase of the scrubber is designed so that solids are able to sediment out and to concentrate in the conical base. Solids present, beside the monomer, include PLA dust, which forms together with the granules at the granulation stage or is produced from the granules by abrasion in the pipelines and apparatuses and is entrained by the exhaust gas stream. From the liquid phase of the scrubber, the concentrated suspension is drawn off with a suitable pump 23 which is able to convey solids-containing liquids. This slurry is supplied to a lactide preparation process stage, in which the transport water can be removed without damage to the product it contains, and the monomer and the dust can be utilized. A suitable example for this purpose is the process of lactic acid dewatering, in which the incoming lactic acid, of around 90%, is concentrated to 100% (this may take place, for example, in accordance with EP 2 030 667 B 1, column 9 “Concentration of lactic acid”). This recycling turns the solids—otherwise considered as waste—back into PLA granules.

Alternatively to this, the solids present in the scrubbing water can also be deposited using a filter 24. In that case, the filter cake is removed from time to time, stirred up to a fluid suspension with water or lactic acid, and passed to the lactic acid dewatering process.

Water losses in the scrubber circuit, arising as a result of the withdrawal, are compensated by supply of demineralized water 22.

Downstream of the scrubber, the purified inert gas has a dew point corresponding to the temperature of the scrubbing water applied to the bed of packing. Before the inert gas can be returned to the tower apparatus, it is dried. This is done preferably in two stages: initially, in a cooler 19 with cold water to, for example, 6° C., in order to unburden the adsorption air drier 21 used in the second stage, which sets the required dew point of at least −20° C., preferably −40° C. Downstream of the cold water cooler, the thawed moisture is present partly in the form of mist. It is deposited in the droplet and mist separator 20 and goes back into the scrubber. The adsorption air drier is regenerated with heated air. Where air is used as inert gas, a suitable unit, for example, is a drier from Munters, Hamburg, which operates continuously with an adsorption wheel. With nitrogen as the inert gas, a suitable unit is a solid-bed drier from, for example, Silica Gel Verfahrenstechnik Berlin. After the dew point has been established, the inert gas stream can be divided over branches 11 and 12 in order to close the circuit.

Where nitrogen is used as inert gas, circulation is necessary owing to the costs of the gas. When dried air is being used as inert gas, circulation is not absolutely necessary. The air could also be taken from the environment and, after filtering and drying, used for the demonomerization and released into the environment following recovery of the lactide. The advantage of circulation, however, is that it is independent of weather conditions and air impurities, and of avoiding the supply of demineralized water that is necessary in order to make up the losses with the outgoing air. Circulation therefore contributes to water saving and to operational security. The equipment needed for the drying of the air and for the scrubbing of the outgoing gas are necessary in the case both of withdrawal from and delivery to the ambient air and also in the case of circulation, and so circulation does not give rise to an extra economic expense.

### Course of the Method According to Embodiment b

In another embodiment b) of the invention, the object is achieved by heating in conjunction with crystallization of the granules in a separate apparatus with a horizontal stirrer, and by completion of the demonomerization in a second, vertical tower apparatus attached thereto. The maximum temperature in the crystallizer and in the attached tower apparatus are selected as in embodiment a). The inert gas laden with monomer is purified by scrubbing with water as in embodiment a) and is passed in circulation.

With this embodiment as well, the residual monomer content of the granules of 0.2% can be achieved within a residence time of less than 20 hours for the granules in the apparatus. This embodiment has the advantage of requiring a smaller inert gas stream than in embodiment a) and therefore smaller apparatuses for the cleaning, drying, and recycling of the gas.

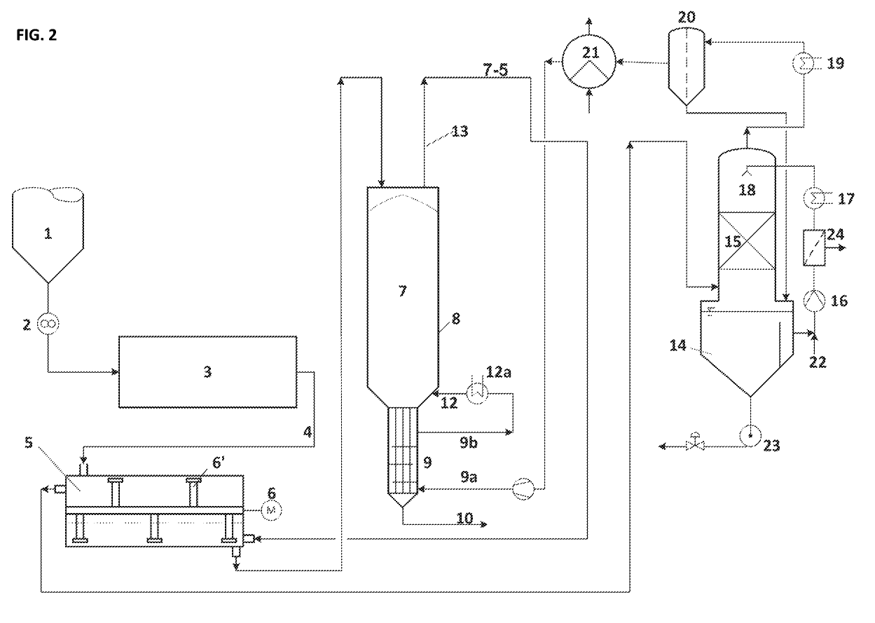

The course of the method according to embodiment b) is depicted in FIG. 2. In the figure, identical reference symbols denote identical components and in some cases are not elucidated separately again.

As described above under embodiment a), PLA is produced from lactic acid in a continuous plant. The monomer-containing melt, which may contain between 2% and 20% lactide, is drawn off from the polymerization reactor 1 and supplied to a granulating device 3. A suitable granulating device in this embodiment as well is an underwater hot cut pelletizer, an underwater strand pelletizer, or any other granulating device which is able to produce free-flowing granules having a specific particle mass of between 5 and 100 mg.

The amorphous granules are supplied to a separate crystallizer 5. A suitable crystallizer is a so-called plowshare mixer having a horizontal stirrer shaft 6 which bears stirring arms 6′ which at their end carry plowshare-like mixing and conveying elements. These elements prevent the granules sticking to the wall and ensure separation of the agglomerates which form during the crystallization, and also mix and convey the bed of granules from the inlet to the outlet. The jacket compartment of the crystallizer 5 is designed as a horizontal cylinder with the stirrer shaft disposed in its axis. The apparatus is filled maximally up to the stirrer shaft with granules. It can be heated externally with a heat transfer medium (steam, water, oil), so that the granules can be heated to the crystallization temperature by contact with the heated wall. Inert gas is passed through the vessel, preferably in countercurrent to the principal flow direction of the granules. The inert gas stream serves to take off the monomer which is liberated from the granules during crystallization. The inert gas supplied to the plowshare mixer is preferably the exhaust gas 13 of the subsequent demonomerization zone 7 in the tower apparatus 8, via a line 7-5. The exhaust gas from the plowshare mixer is purified with a scrubber 14, dried, and circulated, as described for embodiment a). The solids deposited (monomer and PLA dust) are returned to the operation in the same way, as described above.

Instead of a crystallizer 5 in the form of a plowshare mixer, it is possible for a rotary drum apparatus to be used as crystallizer 5. A rotary drum, rotating horizontally about its axis, is provided with an inlet and an outlet for granules and inert gas. Granules are fed to the inside of the rotating drum, which moves the granules from the inlet to the outlet by means of a welded-on spiral belt. The rotation of the drum maintains the granules in continual movement and so prevents the formation of agglomerates. Granule throughput and residence time are adjusted via the rotary speed and the degree of filling of the drum. On its path through the drum, the stream of granules is heated by infrared lamps which are in a fixed disposition over the length of the drum. The granules temperature is controlled via the heating power of the lamps. The monomer liberated from the granules during crystallization is taken off with the inert gas stream, which is guided through the rotating drum preferably counter to the principal flow direction of the granules.

The rotating drum apparatus is preferably also supplied with the exhaust gas 13 of the subsequent tower apparatus 8 for the crystallization. Exhaust gas purification and solids recycling take place as described for embodiment a).

The precrystallized granules from the crystallizer 5 are supplied to a tower apparatus 8, which in this embodiment contains no crystallization zone and no stirrer. In the demonomerization zone 7, the temperature of the now semicrystalline granules is increased to up to 5° C. below the crystalline melting point. This is accomplished by introducing an inert gas stream 12, preheated to the desired temperature, at the lower end of the demonomerization zone, before that zone turns into the granules cooler 9. In this case the heat capacity of the gas (the arithmetic product of the mass flow of the gas and its specific heat capacity) must be greater than the heat capacity of the granules (the arithmetic product of the mass flow of the granules and its specific heat capacity). The inert gas mass flow supplied into the lower section of the tower apparatus in accordance with FIG. 2 must therefore be at least 2.0 times the mass flow of the PLA granules, preferably at least 2.5 times, and typically 3.0 times. Only in that case is it possible to set the desired granules temperature by means of the temperature of the gas supplied.

For a residence time of 20 h by the granules in the demonomerization zone, preferably less, the residual monomer content is lowered to 0.2% or below.

The granules flow subsequently, in the form of a moving bed, into the granules cooler 9, which has already been described in the context of embodiment a).

### Course of the Method According to Embodiment c

A further embodiment c) involves a two-stage demonomerization: it combines removal of the lactide from the polymerized melt by vacuum evaporation in the 1st stage, and—following granulation of the melt—from the solid PLA granules in the second stage. This embodiment is suitable when the monomer content of the melt after the polymerization is high. In the absence of this requirement, the embodiment leads to particularly short residence times in stage 2 of <10 h. Since the demands imposed on the residual lactide concentration of the product in the first stage are not high (the final value is brought about only in the second stage), it is possible to use an inexpensive apparatus without moving parts, such as a falling strand apparatus, for example. The second stage uses a tower apparatus with crystallization stage in accordance with embodiment a), or with separate upstream crystallizer as in embodiment b). The lactide is recovered in the first stage by condensation in liquid form at a pressure above the triple point of the lactide. In the second stage, the lactide-containing inert gas is washed with water as in embodiment a) and circulated. The monomer deposited is recycled as described therein.

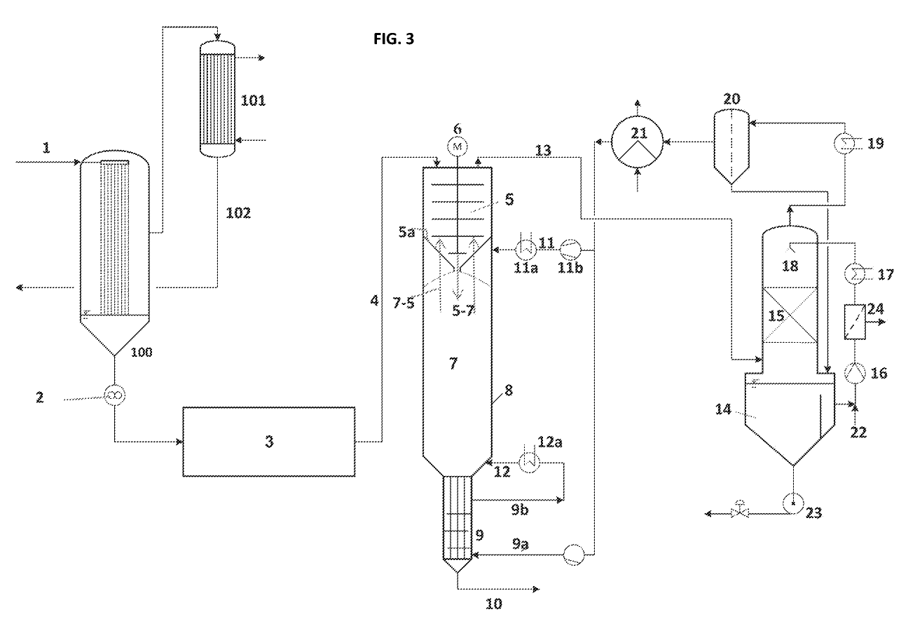

The course of the method according to embodiment c) is depicted in FIG. 3. Here again, identical reference symbols relate to identical constituents and in some cases are not separately described again. This embodiment is preferred when the melt after the polymerization contains more than 5% of monomer or when particularly short residence times for the demonomerization in the solid phase are desired.

As described above under embodiment a), PLA is produced from lactic acid in a continuous plant. The monomer-containing melt 1, which may contain between 2% and 20% lactide, is drawn off from the polymerization reactor and supplied to a falling strand devolatilizer 100. There the melt is divided, by means of a nozzle plate arranged at the upper end, over a multiplicity of vertical holes, and is divided accordingly into strands, which under the action of gravity fall downward via a section dictated by the measurements of the container. A reduced pressure is produced in the container, this pressure being above the triple point of the lactide, e.g., being situated at 10 mbar. The monomer contained in the melt evaporates from the strands and is passed into a condenser 101, where it condenses in liquid form on cooled surfaces. The temperature maintained therein must be above the lactide melting point, in other words 110° C., for example. The monomer is collected in the condenser and passes back into the upstream parts of the plant, as for example into the lactide reservoir of the ring-opening polymerization, or into the lactide purification system (reference symbol 102).

The strands of melt in the falling strand devolatilizer enter the melt reservoir at the container base. Pump 2 maintains a mandated fill level and conveys the melt into the granulating device 3. A suitable granulating device in this embodiment is an underwater hot cut pelletizer, an underwater strand pelletizer or any other granulating device which can produce free-flowing granules having a specific particle mass of between 5 mg and 100 mg.

The amorphous granules enter the crystallization zone 5 of the tower apparatus 8, said zone 5 being equipped with a vertical stirrer 6 in order to prevent agglomerates. This apparatus is exactly as described in embodiment a). In particular, the same granule temperatures and inert gas quantities are maintained as in embodiment a). After traveling through the crystallization zone 5, the demonomerization zone 7, and the granules cooler 9, the granules contain less than 0.2% lactide and are passed on for storage or for packaging.

The monomer-laden exhaust gas 13 is washed, dried, and returned to the tower apparatus, as described in more detail for embodiment a). The monomer deposited in the scrubber is returned to the process, as likewise described there.

Alternatively, the granules from the granulation may be supplied to a separate crystallizer 5, designed as a plowshare mixer or as a rotary drum apparatus, both of which are described in more detail under embodiment b). In particular, the temperatures specified there are also valid for this embodiment c). After the crystallization, the granules are supplied to a tower apparatus 8, which in this case is implemented without a crystallization zone 5 (see embodiment b). After passing through the demonomerization zone 7 and the granules cooler, the granules contain less than 0.2% lactide and are passed on for storage or for packaging.

The exhaust gas from the tower apparatus is preferably passed through the separate crystallizer, washed, dried, and passed back to the tower apparatus, as described for embodiment b). The monomer deposited in the scrubber is recycled to the process, as described for embodiment a).

In all of the above-stated embodiments of the method of the invention it is possible, rather than water, for the scrubbing liquid used to be lactic acid in any mixing ratio with water. It is particularly economic to use the lactic acid employed in preparing the lactide, which has a water content of 5 to 15%. The monomer deposited from the inert gas remains in the lactic acid, which is subsequently polycondensed and depolymerized to give lactide. In this way, the monomer is recycled to the polymerization process without further intervention.

For all of the above-stated embodiments it is also the case that alternatively to the cooling and washing of the removed lactide with water or lactic acid, the lactide may also be removed from the laden inert gas stream by cooling the inert gas stream and carrying out deposition with customary devices for dry dedusting. The cooling is accomplished, for example, by mixing a cold stream of inert gas into the monomer-laden inert gas stream. In that case, lactide desublimes in dust form and is unable to settle. Suitable devices for depositing the lactide dust are cyclones and textile filters with continuous cleaning by means of vibration or pressure surges. The lactide here is deposited in the form of flowable dust and, after melting, is returned to the polymerization process. Desublimed lactide tends to form an aerosol, and therefore cannot be deposited 100% with the devices stated. Lactide in dust form is abrasive to fans, even at low concentrations, and results in destruction within a short time. Accordingly, the circulation of the inert gas stream is not possible. In order nevertheless to allow complete purification of the inert gas stream, the gas is scrubbed with water. Surprisingly it has been found that scrubbing with water in a gas scrubber of the invention also retains aerosol particles and allows complete purification of the inert gas and hence its circulation. The amount of lactide deposited in the water is small (<0.1%, based on the PLA), and so return to the PLA process is not absolutely necessary.

All embodiments of the invention permit fully continuous operation, by operating without the deposition of the removed residual monomer in solid form in desublimators. This avoids the associated discontinuous operation, consisting of a cycle of evacuation, deposition in solid form on cooled surfaces, pressure increase, melting of the lactide from these surfaces, and take-off of the liquid lactide from the desublimators, renewed evacuation, etc.

The invention can also be applied to PLA granules obtained from “latent heat crystallization”. In granulating systems specifically designed for the purpose, the melt, after division into strands or droplets, is quenched with water only to the point of formation of a solid skin, and is cut while the interior of the strand or droplet is still liquid. The PLA crystallizes from the enclosed melt there, at temperatures below the crystalline melting point of the PLA. During this procedure, the granules are separated from the water and then kept mechanically in motion for a certain time until under external pressure the particles no longer change their shape. The crystalline granules are obtained with a temperature which is between 5 and 50° C. below the melting point of the crystalline PLA. The granules are subsequently transferred directly into a tower apparatus without a crystallization zone, and are demonomerized at temperatures up to 5° C. below the crystalline melting point of the granules. This variant method is suitable preferably for rapidly crystallizing granules having a D content of less than about 2%. In the case of PLA grades with reduced crystallization rate, i.e., with a D content of between about 2% and 6%, it may be advantageous first to transfer the granules into a crystallization zone as per embodiment a) or b), in which they residue until the end of crystallization.

With this variant method, there is no need for the granules to be cooled to temperatures below the glass transition and to be heated up again for the purpose of crystallizing the amorphous granules.

The invention can be applied to PLA having a crystalline melting point of more than 130° C. PLA is composed of L-lactic acid units, with or without admixtures of D-lactic acid units, or of D-lactic acid units with or without admixtures of L-lactic acid units. Whereas PLA composed of the pure L- or D-lactic acid units has a melting point of about 180° C., the melting point falls in line with increasing admixture of the opposite optical enantiomer. At and above a level of about 6% of D-lactic acid units in PLA composed of L-lactic acid units, or of about 6% of L-lactic acid units in PLA composed of D-lactic acid units, a crystalline melting point is no longer observed. When the glass transition temperature (around 55° C.) is exceeded, these PLA grades soften without crystallizing, and form a melt. The demonomerization according to the invention is possible only at temperatures of at least 130° C., however, since it is only there that technically useful process times are achieved (see Tab. 1, bottom). The invention, moreover, requires that the PLA form solid, free-flowing granules. The invention is therefore not applicable to PLA with a melting point below 130° C. or to PLA which has no crystalline melting point.

Laboratory-scale experiments (example 1) have shown that the higher the temperature in the granules, the greater the success of the demonomerization, measured on the basis of the residence time required and the residual monomer content achieved. It is therefore desirable to use a temperature as high as possible. This temperature, however, is limited by the melting point of the granules, above which they can no longer be referred to as granules. Depending on the crystalline state which is achieved in the prior crystallization, and which is characterized by a degree of crystallization and by crystallite size, but no later than about 5° C. below the melting point, the granules soften and form agglomerates. It has emerged that a continuously operated tower apparatus is particularly sensitive to agglomerates, since they interrupt granule flow. At the same time, the demonomerization process comes to a standstill, since the inert gas is no longer able to flow through the agglomerates or to carry off the monomer any more.

For the crystallization of the amorphous granules, there is an even lower temperature limit. Amorphous PLA granules soften on heating above the glass transition temperature (60° C.), and at latest at 80-90° C. At the same time, crystallization begins, and causes the melting point of the polymer, starting from the glass transition point at 60° C., to climb. If the PLA has a sufficient crystallization rate, the ongoing crystallization prevents excessive softening, let alone melting, of the particles when the granules are heated. All that are formed are loose agglomerates, which mechanical movement is able to separate again. If crystallization proceeds too slowly, the heating procedure overtakes the crystallization process, and the granules reside for too long in a tacky to molten state. In that case, there is severe agglomeration and, eventually, coalescence of the particles. The cause of instances of granules sticking to one another has therefore been identified as a PLA crystallization rate too low in relation to the heating rate.

The maximum crystallization rate of PLA lies at about 110 to 130° C., depending on the optical purity of the lactide used for the polymerization. At a higher temperature, the crystallization rate goes down again. It has been found that a temperature of 20° C. below the crystalline melting point of the granules must not be exceeded if the aim is to prevent agglomeration during the crystallization. Here it should be borne in mind that the melting point of the granules decreases as the D content goes up in the case of PLLA or as the L content goes up in the case of PDLA. The temperature limit therefore drops as the amount of the respectively smaller enantiomer fraction goes up.

Although, in a tower apparatus, equal temperatures in crystallization and demonomerization permit simple design and operation, temperatures in the vicinity of the crystalline melting point of the PLA are not possible in this way, and hence also residence time is not optimal or residual monomer content is not optimal. A solution to the problem is to set different temperatures in the crystallization zone (temperature of maximum crystallization rate) and the demonomerization zone (temperature of maximum possible demonomerization rate). The upper temperature limit for the crystallization is therefore about 15° C. below the upper temperature limit for the demonomerization.

Excessive temperature increase in the granules as a result of the heat liberated during the crystallization, which is identified in EP 755 956 B1 as a cause of agglomeration, is prevented by the granules/inert gas countercurrent in the crystallization zone. Without an inert gas stream, the granules typically experience a temperature increase of 18° C. With the above-stated typical mass flow ratios of gas to granules in the crystallization zone, the gas takes up the heat of crystallization from the granules and carries it off. The gas/granules countercurrent in conjunction with the mass flow ratio and the high heat transfer coefficient between gas and granules does not allow a temperature increase in the granules. The mandated temperature of the gas stream is established there. Agglomeration is therefore very much easier to manage than without an inert gas countercurrent.

The present invention is elucidated in more detail by the examples below, but without the invention being confined to the specific parameters illustrated.

For the purposes of the present invention, the definitions below are used.
All percentage figures are percent by mass.
PLLA, PDLA: polylactic acid or polylactide (PLA) comprising predominantly L- or D-lactide, respectively, with a fraction of max. 6% of D- or L-lactic acid units, respectively.
Lactic acid unit: building block of the PLA molecule chain composed of esterified D- or L-lactic acid.
Monomer: this refers primarily to lactide. In the form removed from the polymer or from the inert gas, the monomer, as well as lactide, includes accompaniments, such as the linear dimer and PLA degradation products in a small concentration.
Triple point: the point in the pressure-temperature diagram of a pure substance at which all three phases—solid, liquid, and vapor—coexist. The triple point is the meeting point of the solid/liquid, liquid/vapor, and solid/vapor phase boundary lines.

For pure L-lactide, this point is situated at 96.9° C. and 1.4 mbar. For the purposes of this invention, this value should not be regarded as absolute—it depends on the composition of the lactide in the method presented. The triple point is affected both by the amount of the optical isomers L-lactide, meso-lactide and D-lactide in the lactide, and also by by-products of the PLA polymerization, which in the demonomerization evaporate or sublime together with the lactide.

These products include lactic acid and other cyclic or linear oligomers of PLA, and also degradation products from the PLA polymerization.
Desublimation: direct transition of a substance from the vapor state into the solid state at pressures and temperatures below the triple point, i.e., without passing through the liquid state inbetween. The opposite of sublimation.
Lactide depositor, lactide deposition: this refers below to a technical process apparatus or a technical process operation in which the lactide in vapor form, either from a carrier gas or under reduced pressure, is deposited in solid or liquid form.
Demonomerization: removal, or apparatus for removal, of monomer from a polymer by conversion of the monomer into the gas phase and separation of the monomer-containing gas phase from the polymer. Besides the monomer there are always other volatile components present in the polymer, such as lactic acid, cyclic and linear oligomers, and products of thermal polymer degradation, which are removed together with the monomer. On account of their low concentration as compared with the monomer, they are not further mentioned in the text, and are always included in the term “monomer”.
Falling strand devolatilizer: continuous devolatilizer in which the polymer melt flow is divided by a multiplicity of nozzle holes into strands (or else filaments) which travel in a vertical drop through the interior of an evacuated container. In the drop time between emergence of the melt from the hole and impingement on the container base, monomer that is present undergoes evaporation. From the container bottom, the melt is drawn off and discharged continuously.
Crystalline melting point, crystalline melting temperature: thermoplastic polymers such as PLA may be in semicrystalline or amorphous form below their melting point. Semicrystalline PLA undergoes transition to a melt only at the “crystalline melting point”, i.e., when the crystalline regions in the polymer undergo melting. This melting point is dependent on the optical purity of the polymer, in other words, for example, on the amount of D-lactic acid units in the case of PLLA. The melting point may be between 130° C. (high D content) and 180° C. (low D content). PLLA with a D content of below about 6% is usually in amorphous form following granulation of the melt by quenching with water, but may “crystallize” —that is—undergo transition to the semicrystalline state—on heating beyond the glass transition temperature. In this case, the amorphous polymer initially softens at the glass transition point. On further heating, crystallization begins at 80-90° C., and the polymer becomes solid again as the semicrystalline structure propagates, until it undergoes transition to a melt at the crystalline melting point.

Under technical conditions, PLLA with a D content of more than about 6% is unable to crystallize, and takes the form of a melt above the glass transition temperature (about 60° C.).
Solid phase: semicrystalline PLA below the crystalline melting point, or amorphous PLA below the glass transition temperature.

Physical parameters are determined using the following analytical methods:
Melting point: a sample of the PLA for analysis is heated from ambient temperature up to a final temperature of 200° C. in a stream of nitrogen, at a rate of 10° C/min, in a differential calorimeter (DSC) which records heat flow. The melting point is taken as the maximum of the endothermic melting peak recorded in this procedure. In the case of semicrystalline samples, the melting point during the first heating is taken.

At the 1st heating, amorphous samples frequently do not exhibit a melting point, and, after the sample has cooled from 200° C. to 40° C. at 10° C/min, they are subjected to a second heating operation at the same rate. In this case, usually, a melting peak occurs, whose maximum is reported as the melting point.
Specific heat of fusion: the specific heat of fusion of a semicrystalline sample is calculated from the area below the melting peak and the quantity of sample weighed out. Division by the specific heat of fusion of a fully crystalline PLA (91 J/g) gives the degree of crystallinity.
Residual lactide content of the PLA:

The PLA sample is dissolved in chloroform and precipitated with isopropanol. The precipitated PLA is isolated by filtration, leaving the low molecular mass constituents in the solution. Following addition of pentamethylbenzene as internal standard, the solution is separated into its constituents in a gas chromatograph, on a DB-5; 15/0.32 capillary column, and lactide is detected quantitatively using a flame ionization detector.
NL, normal Liter:

Volume, based on the physical standard state according to DIN 1343.

### EXAMPLE 1

### Laboratory Scale Demonomerization

Laboratory experiments were carried out on the demonomerization of PLA granules in a stream of inert gas. The apparatus consisted of gas washing bottles with an inset frit, which had been introduced into an oven heated with temperature-conditioned oil. The granules took the form of a fixed bed with a height of about 30 mm on the frit, through which preheated inert gas flowed from below. A thermometer for measuring the granules temperature was passed through the lid of the gas wash bottle and placed with its lower end in the middle of the bed of granules. The stream of inert gas was adjusted to 2 Nl/g/h using a flow meter, this amount ruling out any limitation on the demonomerization rate as a result of the amount of gas. The inert gas stream departing the apparatus was taken off to the environment via a liquid closure. This prevents moist air from the environment penetrating the apparatus and affecting the granules.

Inert gases used were synthetic air, and also nitrogen, both at 5.0 purity. Any effect of moisture can therefore be ruled out.

The gas wash bottle filled with granules is inserted into the preheated apparatus and the inert gas stream is commenced. The heating time of the granules to the intended temperature was 45 minutes. The start of the experiment was therefore defined as 45 minutes after the introduction of the bottles into the oven. The error produced as a result is negligible. Amorphous granules were used, in order to prevent release of monomer from the granules as a result of prior crystallization, with a consequent falsification of the result. During heating, therefore, there was agglomeration, which was reversed by shaking the bottle after the heating operation. After a predetermined time, the gas wash bottles were removed from the apparatus and the granules, after cooling to ambient temperature, were analyzed for remaining lactide content. Table 1 contains the results.

TABLE 1
laboratory scale demonomerization

| Experiment No | 1 | 2 | 3 | 4 |
|---|---|---|---|---|
| Inert gas | Nitrogen | Nitrogen | Nitrogen | Air |
| Granules | 130 | 140 | 150 | 150 |
| temperature (° C.) | | | | |

Lactide content/melting point (%)/(° C.):

| | | | | |
|---|---|---|---|---|
| At start of experiment | 0.37/160 | 0.37/160 | 0.37/160 | 0.37/160 |
| After 3 h | 0.29/159 | 0.26/158 | 0.22/163 | 0.25/164 |
| After 6 h | 0.27/159 | 0.25/161 | 0.15/164 | 0.22/165 |
| After 24 h | 0.17/162 | 0.14/162 | 0.10/171 | 0.10/170 |

| Experiment No. | 5 | 6 |
|---|---|---|
| Inert gas | Air | Nitrogen |
| Granules | 150 | 150 |
| temperature (° C.) | | |

Lactide content/melting point (%)/(° C.):

| | | |
|---|---|---|
| At start of experiment | 3.5/160 | 3.5/160 |
| After 2 h | 1.86/161 | 1.74/162 |
| After 4 h | 1.06/164 | 0.86/163 |
| After 6 h | 0.57/165 | 0.56/164 |
| After 24 h | 0.12/170 | 0.11/171 |

It can be seen that the rate of demonomerization increases with the temperature of the granules. For optimum operation, therefore, working as close as possible to the melting point of the granules is desirable. Nitrogen and dry air are equally suitable as inert gases.

At constant temperature, the melting point of the granules increases during the demonomerization. There is therefore no likelihood of melting or softening in the time profile of the demonomerization. A higher temperature level at the demonomerization also results in a higher melting point. Consequently, there is also no risk of melting or softening as a consequence of temperature increase during the demonomerization, provided the melting point measured prior to treatment is not exceeded.

### EXAMPLE 2

### Demonomerization According to Embodiment c

The example shows the demonomerization of PLA granules with a preliminary demonomerization in a falling strand apparatus with subsequent demonomerization in a vertical tower apparatus according to embodiment c), FIG. 3. The results are contained in Table 2 under experiment numbers 1 to 5.

TABLE 2
pilot scale demonomerization

| Experiment No. | 1 | 2 | 3 | 4 |
|---|---|---|---|---|
| Embodiment | c) | c) | c) | c) |
| Granule melting point (° C.) | 170 | 160 | 160 | 150 |
| Lactide content after | 1.5 | 1.8 | 1.6 | 1.9 |
| granulation (%) | | | | |
| Temperature in the | 150 | 145 | 140 | 140 |
| crystallizer (° C.) | | | | |
| Residence time in the | 3.0 | 3.0 | 3.0 | 3.0 |
| crystallizer (h) | | | | |
| Agglomeration in the crystallizer | no | yes | no | yes |
| Temperature in the | 150 | 145 | 140 | 140 |
| demonomerization zone (° C.) | | | | |
| Residence time in the | 5.0 | 5.0 | 5.0 | 5.0 |
| demonomerization zone (h) | | | | |
| Lactide content after | 0.18 | — | 0.25 | — |
| demonomerization (%) | | | | |
| Experiment No. | 5 | 6 | 7 | 8 |
| Embodiment | c) | a) | a) | b) |
| Granule melting point (° C.) | 150 | 160 | 170 | 160 |
| Lactide content after | 1.7 | 3.4 | 3.0 | 3.2 |
| granulation (%) | | | | |
| Temperature in the | 135 | 120 | 120 | 120 |
| crystallizer (° C.) | | | | |
| Residence time in the | 3.0 | 6.0 | 6.0 | 2.0 |
| crystallizer (h) | | | | |
| Agglomeration in the crystallizer | no | no | no | no |
| Temperature in the | 135 | 150 | 160 | 150 |
| demonomerization zone (° C.) | | | | |
| Residence time in the | 5.0 | 10.0 | 10.0 | 16.0 |
| demonomerization zone (h) | | | | |
| Lactide content after | 0.35 | 0.20 | 0.17 | 0.13 |
| demonomerization (%) | | | | |

In a continuous pilot plant, PLA was prepared by ring-opening polymerization of lactide, which was demonomerized in the tower apparatus according to FIG. 3. Monomer-containing melt was drawn off by means of a gear pump from the falling strand apparatus serving for preliminary demonomerization, at a volume flow rate of 40 kg/h, and this melt was supplied for underwater hot cut pelletization. This pelletization produced virtually spherical PLA granules having an average diameter of 2.5 mm. The granules were in the amorphous state, evident from the transparency of the particles.

With a throughput of 40 kg/h, the tower apparatus offers a residence time of 3 h in the crystallization zone and of 5 h in the demonomerization zone. The inert gas used was dried air with a dew point of −40° C. The stirrer ran at a rotary speed of 2/ minute. The granules temperature was set equally in the two zones. The lactide content after granulation was between 1.5 and 2%. Experiment settings No. 1 and 3 showed that the crystallization can still be operated without agglomeration when the difference between PLA melting point and granules temperature is 20° C. The stirrer was able to break up the agglomerates formed, reliably and in a short time. With a temperature difference of 15° C. (Experiment 2) and particularly at a temperature difference of 10° C. (Experiment 4), irreversible agglomeration occurred in the crystallization zone, leading to the blocking of granule flow and to the termination of the experiment. Experiment 1 indicates that within a residence time of 8 h in the tower apparatus (total made up of the residence times in the crystallization zone and in the demonomerization zone), a lactide content of below 0.2% is achievable only with PLA having a melting point of 170° C. Only in that case is the crystallization temperature of 150° C. sufficient for the demonomerization as well. Experiments 3 and 5 in conjunction with 2 and 4 show that PLA melting points of 160° C. and below permit only crystallization temperatures and demonomerization temperatures which are not sufficient to establish a lactide content of below 0.2%. As long as the granules temperature in the crystallization zone is the same as in the demonomerization zone, agglomeration prevents the establishment of higher temperatures at which it might be possible to attain a residual monomer content of less than 0.2%.

### EXAMPLE 3

### Demonomerization According to Embodiment a

The example shows the demonomerization of PLA granules in a tower apparatus without preliminary demonomerization in the melt. The results are contained in Table 2 under experiment numbers 6 and 7.

In a continuous pilot plant, PLA was prepared by ring-opening polymerization of lactide, which was demonomerized according to FIG. 1. Monomer-containing melt was drawn off by means of a gear pump from the polymerization reactor, at a volume flow rate of 20 kg/h, and this melt was supplied for underwater hot cut pelletization. This pelletization produced virtually spherical PLA granules having an average diameter of 2.5 mm. The granules were in the amorphous state, evident from the transparency of the particles.

For a throughput of 20 kg/h of PLA granules, the tower apparatus offers a residence time of 6 h in the crystallization zone and of 10 h in the demonomerization zone. As in example 2, inert gas supplied was dried air having a dew point of −40° C. In view of the lack of preliminary demonomerization, the lactide content after granulation was somewhat more than 3%. The stirrer ran with a rotary speed of 2/ minute.

The granules temperature was adjusted in the crystallization zone to 120° C., a temperature at which roughly the maximum of the crystallization rate of PLA is situated. In the subsequent demonomerization zone, the granules temperature was increased, through a suitable choice of the temperature and of the quantitative flow rate of the supplied air, to a temperature which lay 10° C. below the melting point of the respective PLA grade. As a result of this choice of temperature, there was no agglomeration in the crystallization zone, and the demonomerization was able to be operated at a sufficiently high temperature. The results of experiments 6 and 7 show that in spite of the higher initial concentration, a lactide content of 0.20% or less in less than 20 h residence time was achievable.

### EXAMPLE 4

### Demonomerization According to Embodiment b

The example shows the demonomerization of PLA granules without preliminary demonomerization in the melt, by crystallization in a separate, horizontal crystallizer with subsequent demonomerization in a vertical tower apparatus according to embodiment b). The crystallizer used was a horizontally disposed rotating drum, rotating about its axis, with internal infrared lamps to heat the granules. On its inside, the drum was provided with a welded-on spiral belt in order to guide the granules. The residence time of the granules was adjusted through the choice of the rotary speed to 2 h. The results are contained in table 2 under experiment number 8. As in example 3, the melt did not undergo preliminary demonomerization.

In a continuous pilot polymerization, PLA was produced by ring-opening polymerization of lactide, and was demonomerized in the same tower apparatus as in examples 2 and 3. Monomer-containing melt was drawn off in a melt flow rate of 20 kg/h from the polymerization reactor, by means of a gear pump, and was passed for underwater hot cut pelletization. The pelletization generated approximately spherical PLA granules having an average diameter of 2.5 mm. The granules were in the amorphous state, apparent from the transparency of the particles.

With a throughput of 20 kg/h, the tower apparatus offers a residence time of 6 h in the crystallization zone and of 10 h in the demonomerization zone. In this example, both zones were operated at the same temperature and used for the demonomerization. The crystallization zone of the tower apparatus was operated without a stirrer. As in example 2, dried air with a dew point of −40° C. was supplied as inert gas. Owing to the lack of preliminary demonomerization, the lactide content after pelletization was somewhat more than 3%.

The granules left the pelletization at 50° C. and were adjusted to 120° C. in the outflow, through the heating in the rotary drum crystallizer, this temperature of 120° C. being the approximate location of the maximum crystallization rate of PLA. The granules temperature in the tower apparatus was adjusted, by a suitable choice of the temperature and of the volume flow rate of the air supplied, to a level which, at 150° C., was 10° C. below the melting point of the PLA granules produced. As a result of the crystallization in the upstream rotary drum crystallizer, it was possible to maintain this temperature throughout the tower apparatus. In spite of operation without the stirrer, there was no agglomeration. Accordingly, the demonomerization could be operated at a sufficiently high temperature. The results of experiment 8 show that in spite of the greater initial concentration, this apparatus arrangement as well allows a lactide content of 0.20% to be achieved in less than 20 h residence time.

1.-23. (canceled)

24. A method for crystallizing granules and removing low molecular mass components from the granules of a crystallizable thermoplastic material having a crystalline melting temperature of at least 130° C., the method comprising:
at least partially crystallizing the granules of the crystallizable thermoplastic material in a crystallization stage at a first temperature; and
at least partially removing the low molecular mass components from the at least partially crystallized granules in a removal stage at a second temperature that is different than the first temperature.

25. The method of claim 24 wherein
the first temperature is at least 20 K below the crystalline melting temperature of the crystallizable thermoplastic material, or
the second temperature is higher than the first temperature and up to a maximum of 5 K below the crystalline melting temperature of the crystallizable thermoplastic material.

26. The method of claim 24 wherein in the crystallization and removal stages the granules are traversed by a flow of gas that passes countercurrent to a direction along which the granules are conveyed,

27. The method of claim 26 wherein the gas is fed into the removal stage and after flowing through the granules in the removal stage is withdrawn and fed into the crystallization stage where the gas flows through the granules in the crystallization stage.

28. The method of claim 26 wherein the gas is nitrogen or dried air.

29. The method of claim 26 wherein the gas has a dew point of less than −20° C.

30. The method of claim 26 wherein the gas is a first gas, the method further comprising at least one of cooling the first gas or mixing the first gas with a second gas having a lower temperature than the first gas before the granules are traversed in the crystallization stage by the first gas or a mixture of the first and second gases, wherein the first gas or the mixture of the first and second gases is adjusted to a temperature below 20 K below the crystalline melting temperature of the crystallizable thermoplastic material.

31. The method of claim 24 further comprising feeding the granules into a cooling stage where the granules are cooled to a temperature of less than 80° C. after the granules pass through the removal stage.

32. The method of claim 31 wherein the granules are cooled in the cooling stage either
indirectly in a shell and tube heat exchanger with at least one of a gas or a liquid heat transfer medium that has a temperature that is lower than a temperature of the granules, wherein the granules flow in tubes of the shell and tube heat exchanger and the at least one of the gas or the liquid heat transfer medium flows cross-countercurrent around the tubes; or
by causing a flow of gas that has a temperature that is lower than a temperature of the granules to traverse the granules.

33. The method of claim 32 further comprising:
heating the gas used in the cooling stage to a temperature between 20 K below the crystalline melting temperature of the crystallizable thermoplastic material and a maximum of 5 K below the crystalline melting temperature of the crystallizable thermoplastic material; and
feeding the gas that has been heated into the removal stage.

34. The method of claim 33 wherein
a mass flow of the gas fed into the removal stage or the cooling stage is 2.0-5.0 times a mass flow of the granules fed in, or
a selected heat capacity of the gas flow fed into the removal stage, as calculated as an arithmetic product of a mass flow and a specific heat capacity of the gas, is greater than a heat capacity of a flow of the granules, as calculated as a product of a mass flow and a specific heat capacity of the crystallizable thermoplastic material, wherein a ratio of the heat capacity of the gas flow to the heat capacity of the flow of the granules is adjusted to between 1.25 and 2.5.

35. The method of claim 24 wherein the granules
reside for between 0.5 to 5 hours in the crystallization stage or are crystallized to a degree of crystallization of 20% to 80%; and
reside for between 1 to 30 hours in the removal stage.

36. The method of claim 24 further comprising moving the granules mechanically in the crystallization stage.

37. The method of claim 26 wherein the granules are moved mechanically by way of stirring.

38. The method of claim 24 wherein the low molecular mass components are removed down to a level of below 0.2% by weight.

39. The method of claim 24 wherein the low molecular mass components are removed down to a level of below 0.5% by weight.

40. The method of claim 24 wherein the low molecular mass components are removed down to a level of below 1.0% by weight.

41. The method of claim 24 wherein the crystallizable thermoplastic material is comprised of poly-L-lactic acid having a minimum D-lactic acid unit content of 6%, poly-D-lactic acid having a maximum L-lactic acid unit content of 6%, or copolymers of lactic acid, wherein the low molecular mass components are comprised of L-lactide, D-lactide, meso-lactide, lactic acid, or comonomers.

42. The method of claim 24 further comprising producing the granules as amorphous granules before feeding the granules into the crystallization zone, wherein the granules are produced as the amorphous granules by a polymerization reaction or a polycondensation reaction in a melt and subsequent granulation of a resulting polymer.

43. The method of claim 42 further comprising partially removing the low molecular mass components contained in the melt prior to the granulation.

44. The method of claim 42 further comprising partially removing the low molecular mass components contained in the melt prior to the granulation by way of a falling strand evaporator, under pressure reduced relative to standard conditions.

45. The method of claim 24 further comprising feeding the granules into a cooling stage where the granules are cooled to a temperature of less than 80° C. after the granules pass through the removal stage, wherein in the crystallization and removal stages the granules are traversed by a flow of gas that passes countercurrent to a direction along which the granules are conveyed, the method further comprising purifying the flow of gas after withdrawing the gas from the crystallization stage or the removal stage, wherein the purifying comprises at least partially removing low molecular mass material from the flow of gas.

46. The method of claim 45 wherein the purified gas is fed into the removal stage or the cooling stage and/or the removed lower molecular mass material is used to produce the crystallizable thermoplastic material.

47. A device for carrying out crystallization and removal of low molecular mass components from granules of a crystallizable thermoplastic material, the device comprising:
a crystallization zone for the granules of the crystallizable thermoplastic material, the crystallization zone including an inlet and an outlet for the granules, wherein crystallization of the granules occurs at a first temperature; and
a removal zone for removing the lower molecular mass components from the granules of the crystallizable thermoplastic material, the removal zone including an inlet and an outlet for the granules, wherein the removal zone is downstream of the crystallization zone, wherein removal of the lower molecular mass components occurs at a second temperature that is lower than the first temperature.

48. The device of claim 47 wherein the removal zone comprises a supply line for heated gas that is disposed at or near the outlet of the removal zone.

49. The device of claim 47 wherein the crystallization zone and the removal zone are in fluidic communication such that the granules are transportable from the outlet of the crystallization zone to the inlet of the removal zone and such that gas is transportable from the removal zone to the crystallization zone.

50. The device of claim 47 further comprising a granules cooler, wherein the outlet of the removal zone opens into an inlet of a granules cooler, the granules cooler comprising a feed for a cooling gas, the granules cooler further comprising in a region of the inlet a take-off facility for gas that opens into a supply line for heated gas in the removal zone, which is disposed at or near the outlet, the device further comprising a gas heater disposed upstream of the supply line, wherein the take-off facility opens into the gas heater.

51. The device of claim 47 wherein the crystallization zone further comprises means for mechanically moving a bed of granules of a crystallizable thermoplastic material located in the crystallization zone.

52. The device of claim 51 wherein the means for mechanically moving the bed of granules is a granules stirrer.

53. The device of claim 47 further comprising:
a granulating device disposed upstream of the inlet of the crystallization zone, the granulating device being configured to produce granules from a melt of a cystallizable thermoplastic material, wherein an outlet of the granulating device is in fluid communication via a granules line with the inlet of the crystallization zone.

54. The device of claim 53 further comprising a reactor for producing the melt of the crystallizable thermoplastics material disposed upstream of the granulating device.

55. The device of claim 54 further comprising a device disposed between the reactor and the granulating device for partial removal of low molecular mass components from the melt of the crystallizable thermoplastic material.

56. The device of claim 47 wherein the crystallization zone includes a gas outlet that opens into a scrubbing device for removing low molecular mass components from a gas stream, wherein downstream units free the gas stream of condensables, wherein the gas stream following removal of the condensables is fed into a granules cooler or the crystallization zone.

57. The device of claim 47 wherein either
the crystallization zone and the removal zone are disposed jointly in a tower apparatus, wherein the crystallization zone is in communication with the removal zone via a perforated plate having a conical design and a central opening via which the granules are transferable from the crystallization zone into the removal zone, or
the crystallization zone and the removal zone are separated from one another and are in fluidic communication with one another via a granules line and a gas line.
